(19) United States
(12) Patent Application Publication
(10) Pub. No.: US 2021/0298531 A1
(43) Pub. Date: Sep. 30, 2021

(54) MAGNETIC SAFETY DEVICE FOR FOOD PROCESSING MACHINES

(71) Applicant: SAMMIC, S.L., Azkoitia (ES)

(72) Inventors: Aitor AGUIRREZABALAGA ZUBIZARRETA, Azkoitia (ES); Aitor GOGORZA SEGUROLA, Azkoitia (ES)

(21) Appl. No.: 17/194,989

(22) Filed: Mar. 8, 2021

(30) Foreign Application Priority Data
Mar. 27, 2020 (ES) 202030253

(51) Int. Cl. A47J 43/07; A47J 43/046

(52) U.S. Cl. CPC A47J 43/0794; A47J 43/0722; A47J 43/046

(57) ABSTRACT

A magnetic safety device for food processing machines includes a motor block containing a motor axis, a processing cuvette incorporating a paramagnetic transmitter, and a cover. A rotary downholder rotates on the cover through an opening-closing axis and incorporates an insertion mouth. There is a magnetic detector existing in the motor block and having a tilting positioner body which at one end has a permanent magnet and at the opposite end a rotating bushing capable of receiving the opening-closing axis. In the broken central part of the tilting positioner body, there is at least one abutting protrusion which in its free rotation abuts against at least one abutting and pushing projection of the rotating downholder.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a magnetic safety device for food processing machines. More specifically, it refers to a magnetic safety device specially designed for general-purpose food processing machines structured on the basis of a removable pin, which allows the cover and its components to be removable and the cover itself to be removable with respect to the processing cuvette, and that are associated with a motor axis which allows the processing cuvette to be removable from the motor block. In addition, it consists of interchangeable processing accessories carrying cutting discs, grating discs and ejection accessories for processed foods, etc. The activation of the machine is given by the ignition of the motor block that drives the rotating motor axis and that will be activated only when the permanent magnet of the cover is oriented or aligned with the paramagnetic transmitter housed in the cuvette and this in turn is aligned with the auto-switch housed in the motor block. The opening for the introduction of food into the machine of the invention is made by means of a rocking movement of the rotary downholder, which houses the magnetic safety device on its axis. In this type of food machines, safety is essential, since the user comes into contact with cutting elements, which is why the safety and hygiene standard EN 1678:1998+A1:2010 is applicable, among others: “Machinery for food processing. Vegetable cutting machines. Safety and hygiene requirements”. This rule in favor of safety, reduces the opening range of the cover, preventing the insertion of the user's hand when the machine is operating and its processing accessories are in operation. For this purpose, the norm estimates a maximum opening between the rotary downholder and the insertion mouth of 60 mm. By means of the present invention, the problem is solved, proposing a magnetic safety system, which allows a greater working range of the machine and a faster activation of the same, maintaining said safety limits in the maximum opening of the rotary downholder of the cover. In other words, the performance of the machine is maximised while respecting the safety standard. On the other hand, the conceived safety device has been designed to be reversible by means of a simple angular rotation of the processing cuvette, that is, the processing cuvette, and consequently the food insertion mouth and the outlet mouth, it has several positions for the user to orient it more comfortably in their work environment and allowing the machine to be housed in any position. Additionally, the magnetic device of the present invention allows the elements that compose it; cover, rotary downholder, tilt positioner body to be removable, as they are all inserted on the same axis, which allows good hygiene thereof, cleanliness being essential in this type of machines working with foodstuffs.

### 2. Description of Related Art Including Information Disclosed Under 37 CFR 1.97 and 37 CFR 1.98.

In the current state of the art, devices and machines are known which are intended for operations related to food processing, such as cutting vegetables, grating bread, emulsifying food and other kinds of a similar nature. In general, known machines of the type mentioned above mainly consist of a motor block, which houses a vertically-arranged motor axis and processing accessories for food treatment whose structural characteristics depend on the specific application for which they are intended. These accessories are generally inserted on the motor axis inside the cuvette in which the grating blades or discs are housed, as well as a rotating pusher or downholder element located on the cover intended to close the processing cuvette and push the introduced food. In said cuvette, the foodstuff is introduced through the hole in the cover and thus the food is processed by keeping in contact with the cutting or grating elements by the force exerted by the rotary downholder. Usually this type of machine, which works with food products, has safety devices that, when the various components of the machine are in their respective operating positions, allow the machine to operate. These safety systems are related to the operation of the rotary downholder by the user, so that only the cutting or grating is allowed when the rotary downholder is completely closed. For this purpose, the processing cuvette incorporates a magnet or paramagnetic transmitter that, when detected by the magnetic detector located on the motor block, will allow the machine to start up safely as long as it is in contact with the magnet in the total closure of the rotary downholder.

Thus, there already exist safety devices for cutting machines, such as the one described in utility model U201100601, which develops an additional safety system directly linked to the end of the pusher member by the user of the machine. This device only allows cutting or grating, that is, starting the machine when the cover is perfectly closed. Thus, it has a duplicating system that multiplies the movement exerted with the rotation of the rotary downholder by means of a lever system, which prevents the connection of the magnet with the detector of the cuvette with any small opening or closing rotary movement exerted on the rotary downholder resulting in an operating path of the small machine and performance of work under the same, as food processing is disabled with a minimal opening of the rotary downholder preventing optimization of food processing. On the other hand, said machine allows a single arrangement of the processing machine for work, so the user only has the option of a single working position, which reduces the comfort in using the machine and limits its position to a single position in professional kitchens. The safety device described also does not allow the components of the cover and its own magnet to be removable for their hygiene or replacement.

Another known security system for this type of machine is by means of a processing activation switch that the user must keep activated, that is to say, that in order to start the cutting machine, the user must be constantly pressing the switch. This safety device is known generally as a “dead man” device, because if the user of the cutting machine suffer some kind of accident during the operation thereof, he would automatically and naturally cease to operate the switch so that the cutting machine would immediately disconnect. The disadvantage of this security system is that the user must constantly keep pressing the switch, detracting from the ergonomics of the handling of the cutting machine and not optimizing the working capacity of the machine.

### BRIEF SUMMARY OF THE INVENTION

Compared to the state of the art described above, the present invention has as its object a magnetic safety device for food processing machines, which are made up of a motor block containing a motor axis, a processing cuvette, which incorporates a paramagnetic transmitter and a cover on which a rotary downholder rotates through an opening-closing axis and which incorporates an insertion mouth, and with a magnetic detector in the motor block, and which has the magnetic safety device, a tilting positioner body that at one end includes a permanent magnet and at the opposite end a rotating bushing capable of receiving the opening-closing axis, and in the broken central part of the tilting positioner body contains at least one protrusion stopper that in its free rotation abuts against at least one abutting and pushing projection of the rotary downholder. With this configuration, the magnetic safety device of the invention allows, during both the opening and closing process, a greater operating performance of the machine, backed by the mandatory safety standard, EN 1678:1998+A1:2010: “Machinery for food processing. Vegetable cutting machines. Safety and hygiene requirements”, which establishes that the maximum opening between the rotary downholder and the insertion mouth must be 60 mm to prevent the insertion of the hand by the user and thus avoid cutting when the machine is activated. Due to the tilting of the tilting positioner body of the permanent magnet, a greater range of activation of the machine is achieved, which will not require a complete closing of the rotary downholder for its operation, which means the possibility of introducing a greater number of foods to be processed in the insertion mouth and a quick and almost instantaneous activation of the machine. Thus, when the foodstuff to be processed is introduced in the maximum opening range, when the rotary downholder is at an angle of 53° with respect to the insertion mouth of the processing cuvette, the rotary downholder being at its maximum opening of 60 mm, the machine is inactive. This is because the abutting and pushing projections the cover are in contact with the abutting protuberances of the tilting positioner body, blocking the free rotation of the tilting positioner body, which due to the action of the force of gravity will wish to rotate in the opposite direction and ensure the containment of the tilting positioner body so that it does not face the paramagnetic transmitter at its maximum opening point. As it is not aligned therewith, the machine is not activated at its 60 mm opening, ensuring that the processing accessory does not function when the user could put his hand through the insertion mouth.

However, when the rotary downholder is located at less than 53° with respect to the processing cuvette's insertion mouth (normally from 50°), the magnetic detector housed in the motor block detects that the tilting positioner body situates the permanent magnet, orienting it vertically relative to the paramagnetic transmitter attached in the processing cuvette and at this moment the operation of the machine starts without the need for a complete closure of the rotary downholder on the cover. This will provide a faster activation of the machine, which, despite not having its rotary downholder completely closed, and since all its activation elements are sufficiently oriented and magnetically connected, they will allow the motor axis to rotate. Therefore, the permanent magnet, the paramagnetic transmitter and the magnetic detector will be connected, the machine activating from <53° of opening of the rotary downholder with respect to the insertion mouth, having its maximum connection (being perfectly aligned) at 27° of opening, which maximizes the working capacity of the machine with optimum safety for the user. This is because of the tilting configuration of the tilting positioner body housing the permanent magnet and the guiding and stop performed by the abutting and pushing projections with the abutting protuberances of the tilting positioner body, and that will allow the permanent magnet to be oriented with the paramagnetic transmitter before, the rotation of the tilting positioner body not being linked to the rotation of the rotary downholder of the cover; and allowing its magnetic capacity to come into contact earlier with the paramagnetic transmitter. Furthermore, due to the broken configuration of the central part of the tilting positioner body, it is ensured that the maximum area of the permanent magnet is facing the paramagnetic transmitter since, with the angulation of said jog, the angulation of said jog also counteracts the opening and closing angulation of the rotating downholder of the cover, optimizing the orientation of the permanent magnet surface with the paramagnetic transmitter. With complete closure, i.e. the rotary downholder being at 0° relative to the insertion mouth of the cover, the abutting and pushing projections of the cover stop cease to be in contact with the abutting protuberances of the tilting positioner body, and there is total closure, while the machine is already operative from at least 50° of opening. At this moment of complete closure, the tilting positioner body positions the permanent magnet by aligning vertically with the paramagnetic transmitter by gravity and by rotation of the tilting positioner body on the opening-closing axis that takes place freely. Thanks to all the aforementioned, an additional functioning range of operation of the machine is achieved in the cover closing process (from 50° to 0°) and in summary, this allows a greater insertion of food to be processed and greater efficiency of the machine while maintaining the safety of the user. On the other hand, the configuration of the magnetic safety device inserted in the opening-closing axis allows all the elements that compose it to be removable, which facilitates their cleaning and replacement. Another characteristic advantage of the invention is that the motor block shall have more than one magnetic detector capable of facing the paramagnetic transmitter in various angular positions of the processing cuvette with respect to the motor block. This is the great advantage of making the machine reversible, that is, thanks to the addition of magnetic detectors in different positions on the motor block, the processing cuvette can also be placed in different angular positions, and this means that the user can configure the processing cuvette, adapting it to the area of work, providing versatility and ergonomics of the machine, since, by rotating with the processing cuvette's motor axis, there can be a different orientation of the processing cuvette's outlet mouth and, consequently, of the foodstuffs' insertion mouth.

Another characteristic advantage of the invention is that the magnetic detector is preferably of two diametrically opposed to perform the reversibility of the machine which provides comfort and ergonomics to the user, as mentioned above. The increasingly reduced dimensions of professional kitchens must be taken into account, as well as the fact that many types of machines are used simultaneously, which determines the need for the machines to be used in different positions to ensure space optimization and the simultaneous use with other stations or processing machines that makes space limited.

Another characteristic advantage of the invention is that the abutting and pushing projections are preferably two, which increases the safety at the time of contact of the abutting and pushing projections with the abutting protrusions of the tilting positioner body and ensures correct orientation or vertical alignment of the permanent magnet with the paramagnetic transmitter. Although other embodiments can logically be provided with a single abutting and pushing projection or a single abutting protuberance or even without these with a corresponding abutting configuration of the tilting positioner body itself and the end of the rotary downholder.

Finally, another characteristic advantage of the invention is that the opening-closing axis is made up of a removable pin and an intermediate bushing. This allows all the elements of the cover to be removable, which facilitates the cleaning and hygiene of the machine, which is decisive when dealing with food. Thus, all the elements that come into contact with both the food and the user's hands are removable; processing cuvette, cover, rotary downholder, which facilitates its washing and cleaning. Likewise, and being incorporated in the same opening and closing axis, the tilting positioner body and the rotating downholder, these and their elements; permanent magnet, can be cleaned in case of splashing, for example, or replaced in case of deterioration. Likewise, both the removable pin and the intermediate bushing may be replaced in case of breakage. This rotation bushing inserted into the opening-closing axis is ensured by the intermediate bushing inserted under pressure or in a rotating manner, and any other usual means of binding can be used such as are nuts, screws or plates.

### BRIEF DESCRIPTION OF THE SEVERAL VIEWS OF THE DRAWINGS

In order to better understand the nature of the invention, an arrangement is presented in the attached drawings which is merely illustrative and non-limiting.

FIG. 1 shows a longitudinal section view of the food processing machine (1), in the 53° and 60 mm opening position of the rotating downholder (5a), with respect to the insertion mouth (5c) of the cover (5) and the processing cuvette (3): The motor block (2) is also observed, which incorporates the magnetic detectors (6) in its upper part, as well as the paramagnetic transmission shaft (7) that is attached to the processing cuvette (3) and incorporating the processing accessory (8), and this is inserted into the drive shaft (10). In addition, a detail view is presented in which are shown; the tilting positioner body (4), which incorporates the permanent magnet (4a), and which in its broken central part (4d) contains the abutting protrusions (4b) that are in contact with the abutting and pushing projections (5b). Likewise, the removable pin (5d) housed axially in the intermediate bushing (5e) and the opening-closing axis (9) can be seen, in which the elements described rotate. Finally, a detailed view is shown, in this case in perspective, of the tilting positioner body (4) composed of a permanent magnet (4a) and abutting protrusions (4b) housed in the broken central part (4d) and attached to the turning bushing (4c) of the tilting positioner body (4).

FIG. 2 shows a longitudinal sectional view of the food processing machine (1), in the opening-closing position and specifically at 50° of opening of the rotating downholder (5a) with respect to the insertion mouth (5c) of the cover (5) and the processing cuvette (3) housed on the motor block (2), which incorporates the magnetic detectors (6). The paramagnetic drive shaft (7) attached to the processing cuvette (3) and the processing accessory (8) inserted into the drive shaft (10) and within the processing cuvette (3) can also be observed. In addition, a detail view is presented in which are shown; the tilting positioner body (4) which, by having its abutting protrusions (4b) in contact with the abutting and pushing protrusions (5b), direct the magnetic force of the permanent magnet (4) towards the paramagnetic transmitter (7) which will allow for magnetic connection without being fully aligned with each other. The removable pin (5d) is also observed, housed axially in the intermediate bushing (5e) and opening-closing axis (9), wherein all the elements described rotate.

FIG. 3 shows a longitudinal section view of the food processing machine (1), in the intermediate opening-closing position and specifically at 27° of opening of the rotating downholder (5a), with respect to the insertion mouth (5c) the cover (5) and the processing cuvette (3) mounted on the motor block (2) incorporating the magnetic detectors (6). The paramagnetic transmission shaft (7) attached to the processing cuvette (3), the processing accessory (8) housed in the processing cuvette (3) that is inserted into the motor axis (10) and finally, a detail view showing; tilting positioner body (4), incorporating the permanent magnet (4a) fully aligned vertically with the paramagnetic transmitter axis (7), since the abutting protuberances (4b) are in contact with the abutting and pushing projections (5b) maintaining the alignment of the tilting positioner body (4). The removable pin (5d) housed axially in the intermediate bushing (5e) and the opening-closing axis (9) can also be seen, in which all the elements described rotate.

FIG. 4 shows a longitudinal section view of the food processing machine (1), in the completely closed position with the rotating downholder (5a) at 0° with respect to the insertion mouth (5c) of the cover (5) and the processing cuvette (3) that is incorporated in the upper part of the motor block (2), which in turn incorporates the magnetic detectors (6). The paramagnetic transmission shaft (7) attached to the processing cuvette (3) is also observed, which also incorporates the processing accessory (8) all inserted into the motor axis (10). Finally, a detail view in which are shown; the tilting positioner body (4), which incorporates the permanent magnet (4a) vertically aligned with the paramagnetic transmitter axis (7) by the action of gravity and by magnetic attraction between them, without being in contact the abutting protuberances (4b) with the abutting and pushing projections (5b). Also, the removable pin (5d) housed axially in the intermediate bushing (5e) is observed and generates the opening-closing axis (9), wherein the elements described rotate. Furthermore, it is observed that the possible outward rotation of the tilting positioner body (4) is limited by the configuration of the cover that acts as a stop at this moment for the rotation of the tilting positioner body (4).

FIG. 5 shows an exploded view of the food processing machine (1) in the 0° full closing position of the cover (5) with respect to the insertion mouth (5c), and comprising an motor block (2) in which the magnetic detectors (6) and the motor axis (10) are housed diametrically opposed to each other by means of which the processing cuvette (3) is attached, which consists of an outlet mouth (3a), and which contains attached the paramagnetic transmitter (7). On the other hand, to said processing cuvette (3) is vertically coupled the cover (5) consisting of a rotary downholder (5a) and an insertion mouth (5c), said elements being articulated through an opening-closure shaft (9) constituted by a removable pin (5d) housed in an intermediate bushing (5e). In addition, between the lower part of the cover (5) (not visible in FIG. 5) and the processing cuvette (3), the processing accessory (8) is housed. Finally, a view shown in detail of the tilting positioner body (4) comprises a permanent magnet (4a) and abutting protuberances (4b) housed in the broken central part (4d) and which is attached to the rotation bushing (4c) of the tilting positioner body (4).

FIG. 6 shows a longitudinal sectional view of the food processing machine (1), in the fully closed position and being a processing cuvette (3) in a different angular position to the other Figures and in order to show the reversibility of the machine by turning the processing cuvette (3) together with the cover (5) and its elements. It can be seen in this Figure that more than one magnetic detector (6) is foreseen in the motor block (2), one of them facing the paramagnetic transmitter (7), thus allowing the activation of the machine and the output of the processed food in different positions through the outlet mouth (3a) of the processing cuvette (3).

The following references are indicated in these Figures:

1. Food processing machine

2. Motor block

3. Processing cuvette

3a. Outlet mouth

4. Tilting positioner body

4a. Permanent magnet

4b. Abutting protuberance

4c. Rotating bushing.

4d. Broken central part

5. Cover

5a. Rotating downholder

5b. Abutting and pushing projection

5c. Insertion mouth

5d. Removable pin

5e. Intermediate bushing

6. Magnetic detector

7. Paramagnetic transmitter

8. Processing accessory

9. Opening-closing axis

10. Motor axis

### DETAILED DESCRIPTION OF THE INVENTION

With regard to the above-listed drawings and references, a preferred mode of execution is illustrated in the attached drawings of the object of the invention referred to a magnetic device for the safety of food processing machines (1), which are constituted by a motor block (2) containing a drive shaft (10), a processing cuvette (3), which incorporates a paramagnetic transmitter (7) and a cover (5) on which a rotary downholder (5a) rotates through an opening-closing axis (9) and which incorporates an insertion mouth (5c), and there being in the motor block (2) a magnetic detector (6), having a tilting positioner body (4) that at one end has a permanent magnet (4a) and at the opposite end a rotating bushing (4c) capable of receiving the opening-closing axis (9), and in the broken central part (4d) of the tilting positioner body (4) contains at least one abutting protrusion (4b) that in its free rotation abuts against at least one abutting and pushing projection (5b) of the rotary downholder (5a).

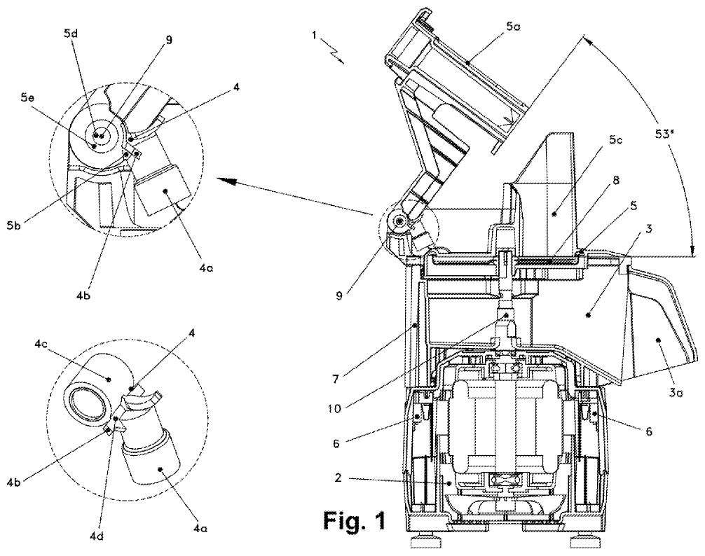

As can be seen in FIG. 1, the rotary downholder (5a) of the food processing machine (1) is in an angular opening position of 53°, with respect to the insertion mouth (5c) of the processing cuvette (3), that is, in the maximum opening position of the rotary downholder (5a) with the machine in operation (exactly less than 53° with respect to the insertion mouth (5c) of the processing cuvette (3)) and fulfilling the requirements of the aforementioned standard, EN 1678:1998+A1:2010: “Machinery for food processing. Vegetable cutting machines. Safety and hygiene requirements” which establishes a maximum opening between the rotary downholder (5a) of the cover (5) and the insertion mouth (5c), of 60 mm, when the machine cannot be in operation. Thus, in this total opening of the food processing machine (1), its safety device acts preventing its operation, since the abutting and pushing projections (5b) are in contact with the abutting protuberances (4b) of the tilting positioner body (4), preventing the tilting positioner body (4) from having rotational freedom, due to the force of gravity and being inserted in the opening-closing axis (9) by means of the removable pin (5d) through the rotating bushing (4c), and preventing its orientation and alignment with the paramagnetic transmitter (7) and therefore, the activation of the motor axis (10) activating the processing accessory (8). Thanks to the rotating or tilting constitution of the tilting positioner body (4) and its guidance and stop 10 through its abutting protuberances (4b), it is possible to limit the free rotation of the latter, preventing its orientation and magnetic connection when its use would be unsafe for the user (at maximum opening of the rotary downholder (5a). This is due to the connection of the machine's activation of the orientation or alignment of the permanent magnet (4a) to the paramagnetic transmitter (7) and this to the magnetic detectors (6), and, as shown in FIG. 1, the rotary downholder (5a) and the tilting positioner body (4) are linked to the same opening-closing axis (9), turning both on the same axis but being limited and directed the free rotation of the tilting positioner body (4), which falls by gravity, and due to its abutting protrusions (4b) of the broken central part (4d), which make contact with the abutting and pushing protrusion (5b) of the rotating downholder (5a) preventing alignment and, thus, undesired activation of the machine in an insecure opening of 60 mm. Thus, when the food to be processed is introduced, the rotary downholder (5a) is at an angle of between 180° and 53° with respect to the insertion mouth (5c) of the processing cuvette (3). On the contrary, when the rotation and consequent lowering of the rotary downholder (5a) to <53° begins, this pushes the food towards the processing accessory (8) and the machine is activated. Thus, during the angular path of closing of the rotary downholder (5a) with respect to the insertion mouth (5c) of the processing cuvette (3), from less than 53°, the food processing machine (1) is in operation, that is, the motor axis (10) rotates and applies rotary movement to the processing accessory (8). This is because the magnetic detector (6) is detecting the vertical orientation of the permanent magnet (4a) with the paramagnetic transmitter (7), and, despite not being completely aligned and because of its magnetic capacity it enters in contact between them due to the rotation of the tilting positioner body (4) with the consequent activation of the machine, but guaranteeing its safety.

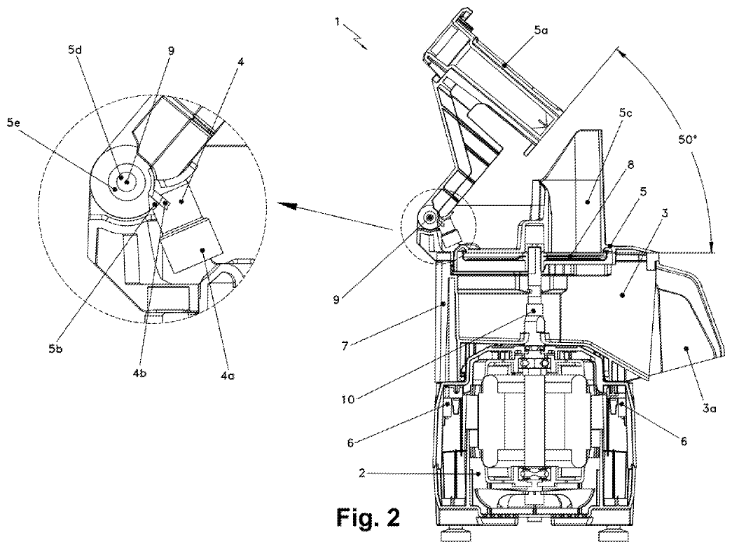

This can be seen in FIG. 2, as an illustrative example of the activation of the machine without the permanent magnet (4a) of the tilting positioner body (4) being fully aligned with the paramagnetic transmitter (7), which will occur from <53° to <27° with respect to the insertion mouth (5c) of the processing cuvette (3). Thus, in this FIG. 2 it can be observed that with the mere orientation of the permanent magnet (4a) of the tilting positioner body (4) with the paramagnetic transmitter (7), the machine will be activated since, from <53°, the magnetic detector (6) housed in the motor block (2) detects the permanent magnet 5 (4a) oriented to the paramagnetic transmitter (7) since all the activation elements are sufficiently oriented and magnetically connected. This is due to the fact that the abutting and pushing projections (5b) are in contact with the abutting protrusions (4b) of the tilting positioner body (4), blocking the free rotation of the tilting positioner body (4) and orienting the tilting positioner body (4) towards the paramagnetic transmitter (7). Thus, the motor axis (10) will rotate beforehand, that is, the permanent magnet (4a), the paramagnetic transmitter (7) and magnetic detector (6) will be magnetically connected, activating the machine beforehand and maximizing the work capacity of the machine with optimum safety for the user.

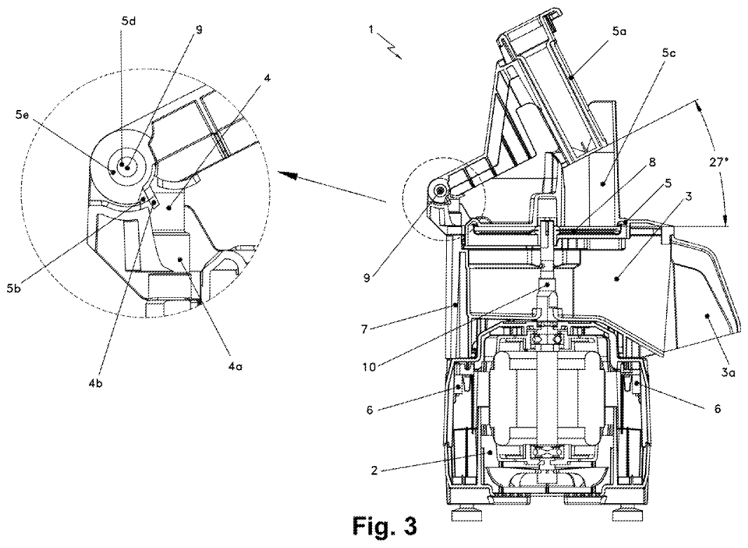

In the intermediate opening shown in FIG. 3 to 27°, the abutting and pushing projections (5b) are in contact with the abutting protuberances (4b) of the tilting positioner body (4). These block the free rotation of the tilting positioner body (4), guiding the tilting positioner body (4) to the alignment of the permanent magnet (4a) with the paramagnetic transmitter (7), which will mean the activation of the machine without the rotary downholder (5a) since the machine is active from <53° of the rotary downholder (5a) with respect to the insertion mouth (5c). Likewise, it can be seen in FIG. 3 that when the rotating downholder (5a) is located in the intermediate opening position of 27° with respect to the insertion mouth (5c) of the processing cuvette (3), the magnetic detector (6) housed in the motor block (2) detects that the permanent magnet (4a) of the tilting positioner body (4) is perfectly vertically aligned with the paramagnetic transmitter (7) attached in the processing cuvette (3), there being the maximum magnetic field between them and the consequent operation of the food processing machine (1) without the need for a complete closure of the rotary downholder (5a).

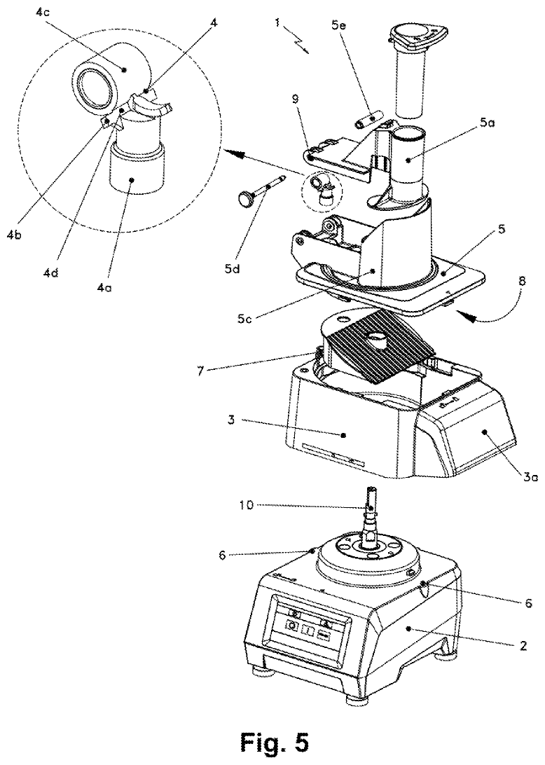

Therefore, there will be a rapid and almost simultaneous activation at the beginning of the rotation of the rotary downholder (5a) in the closure of the food processing machine (1), all its activation elements being sufficiently oriented (at less than 53°) or perfectly aligned (at 27°) and magnetically connected; permanent magnet (4a) and paramagnetic transmitter (7) which is detected by the magnetic detector (6), maximizing the worktime of the food processing machine (1) with optimum safety for the user. This is mainly due to the tilting configuration of the tilting positioner body (4) housing the permanent magnet (4a) and because its tilt or rotation is not linked to the rotation of the rotary downholder (5a) and also to the guidance that is performed of the tilting positioner body (4) with the abutting and pushing projection (5b) that will allow the permanent magnet (4a) to be oriented beforehand or aligned in its free rotation with the paramagnetic transmitter (7) and thus also detected beforehand by the magnetic detector (6), and without the rotary downholder (5a) being completely closed. Furthermore, with the configuration of the tilting positioner body (4) it is ensured that the maximum surface area of the permanent magnet (4a) is oriented to the paramagnetic transmitter (7) thanks to the angular configuration of the broken central part (4d) of the tilting positioner body (4), which is reflected in the detail view of FIG. 5 and allowing greater orientation of the surface of the permanent magnet (4a) and therefore its magnetic capacity, thereby remaining the paramagnetic transmitter (7) oriented beforehand in the opening-closing rotation of the rotary downholder (5a) and detected beforehand by the magnetic detector (6).

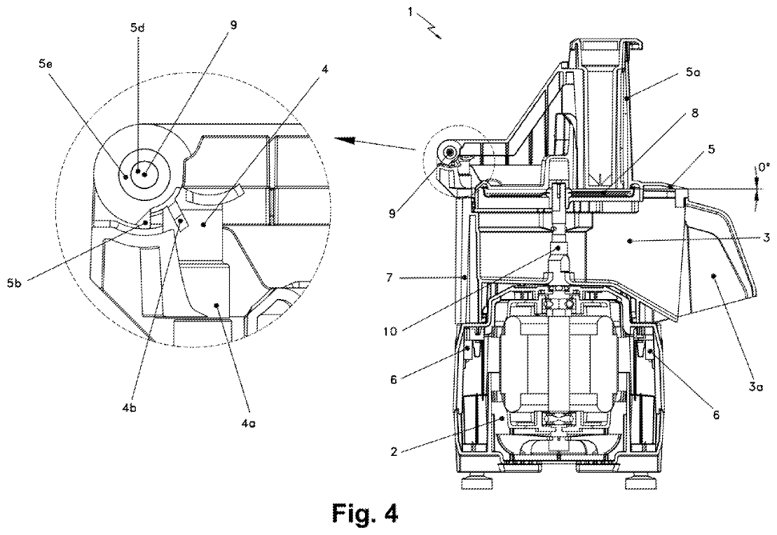

With the complete closure of the rotary downholder (5a), being at 0° with respect to the cover (5) and as shown in FIG. 4, the abutting and pushing projections (5b) are no longer in contact with the abutting protuberances (4b) of the tilting positioner body (4), the machine being operational, since the permanent magnet (4a) of the tilting positioner body (4) is vertically aligned to the paramagnetic transmitter (7) due to the force of gravity and free rotation thereof on the opening-closing axis (9). With all the above-mentioned, an additional operating range is achieved in the closing of the rotating downholder (5a) from <53° of opening or from <60 mm of opening, obtaining a higher working efficiency of the food processing machine (1), maintaining user safety.

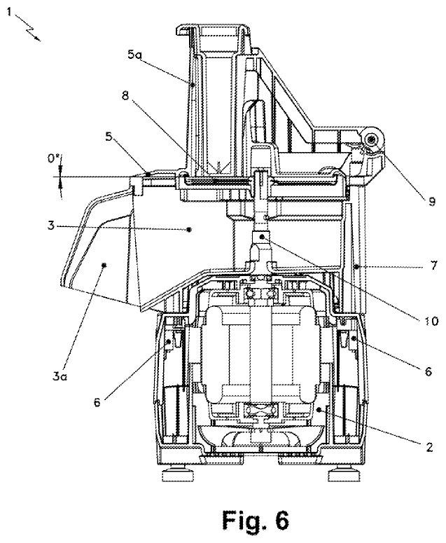

As shown in FIG. 6, another characteristic advantage of the invention is that the food processing machine (1) is reversible, i.e., the processing cuvette (3) may be located at different angular positions. For this reason, in the motor block (2) it is foreseen that there be more than one magnetic detector (6), preferably two diametrically opposed to carry out the reversibility of the food processing machine (1), capable of being faced with the paramagnetic transmitter (7) with any of those magnetic detectors (6) and in different angular positions of the processing cuvette (3) with respect to the motor block (2). In summary, thanks to the addition of magnetic detectors (6) arranged in an angular manner, the user will be able to rotate the processing cuvette (3), allowing the processed food to exit in different positions through the outlet mouth (3a) of the processing cuvette (3), providing versatility in the machine position and ergonomics in the workplace without sacrificing the activation of the safety device.

Thus, the outlet mouth (3a) of the processing cuvette (3), through which the processed food will be discharged, will be located where it is most convenient depending on the specific location of the machine or the location of the operator who uses it.

In order to ensure the correct orientation or vertical alignment of the permanent magnet (4a) with the paramagnetic transmitter (7) the presence preferably of two abutting and pushing projections (5b) of the cover (5) is foreseen so that if one deteriorates, the other may function.

As can be seen in FIG. 5, another characteristic advantage of the invention is that all the elements of the cover (5); rotating downholder (5a), removable pin (5d), intermediate bushing (5e) are removable, in the same manner as the tilting positioner body (4) and permanent magnet (4a) and this is because all these elements are linked by opening-closing axis (9) and are joined by means of a removable pin (5d) that is fixed by pressure or threaded with the intermediate bushing (5e). In this manner, all the elements that make up the cover (5) can be easily disassembled for cleaning and replacement, this being a great advantage because, in professional kitchens work tools are cleaned once a day when these foods are in contact with food products.

Moreover, the processing cuvette (3) is also removable with respect to the block motor (2) and this is due to its insertion through the motor axis (10), which assists complete cleaning and hygiene of the food processing machine (1).

Variations in materials, shape, size and arrangement of the component elements, described in a non-limiting manner, do not alter the essentiality of this invention, this being sufficient to proceed to its reproduction by an expert.

1. A magnetic safety device for food processing machines, comprising:
a motor block containing a motor axis,
a processing cuvette, incorporating a paramagnetic transmitter,
a cover,
a rotary downholder on said cover rotates through an opening-closing axis and incorporates an insertion mouth,
a magnetic detector existing in the motor block,
a tilting positioner body which at one end has a permanent magnet and at the opposite end a rotating bushing capable of receiving the opening-closing axis, and
at least one abutting protrusion in the broken central part of the tilting positioner body which in its free rotation abuts against at least one abutting and pushing projection of the rotating downholder.

2. The magnetic safety device for food processing machines, according to claim 1, further comprising: more than one magnetic detector in the motor block facing the paramagnetic transmitter in different angular positions of the processing cuvette with respect to the motor block.

3. The magnetic safety device for food processing machines, according to claim 1, wherein the magnetic detector is comprised of two diametrically opposed ones.

4. The magnetic safety device for food processing machines, according to claim 1, wherein the abutting and pushing projection is comprised of two.

5. The magnetic safety Device for food processing machines, according to claim 1, wherein the opening and closing axis is comprised of a removable pin and an intermediate bushing.
